(19) United States
(12) Patent Application Publication
(10) Pub. No.: US 2025/0235965 A1
(43) Pub. Date: Jul. 24, 2025

(54) MACHINE TOOL

(71) Applicant: Schwäbische Werkzeugmaschinen GmbH, Schramberg-Waldmössingen (DE)

(72) Inventor: Marcus MIXNER, Hardt (DE)

(21) Appl. No.: 19/022,155

(22) Filed: Jan. 15, 2025

(30) Foreign Application Priority Data
Jan. 20, 2024 (EP) 24153014.6

(51) Int. Cl. B23Q 1/26

(52) U.S. Cl. CPC B23Q 1/265

(57) ABSTRACT

A machine tool having a machine frame, at least one work spindle, at least one workpiece table which is mounted in the machine frame to rotate or swivel about an axis of rotation and which includes a closed, planar partition wall, and which includes at least one first workpiece holder and at least one second workpiece holder. The workpiece table, at least in a loading and unloading mode of the machine tool during production, can be transferred into a separating position in which the separating wall is arranged to extend transversely to the allocated spindle axis and spatially separates a working area, in which the first or the second workpiece holder is arranged in the separating position and is accessible to the associated work spindle, is spatially separated from a loading area in which the second or the first workpiece holder is arranged in the separating position.

### CROSS-REFERENCE

This application claims the benefit of European application EP 24153014.6 filed Jan. 20, 2024, which is incorporated herein by reference.

The invention is a machine tool.

Machine tools are known from the state of the art in various embodiments and designs. For example, these can include machine frames upon which a workpiece table is arranged, where workpieces can be detachably fastened. The workpieces can be processed by a work spindle on the machine tool.

In known machine tools, the workpiece table is loaded with workpieces while the work spindle is out of operation. In addition, the work spindle is at rest if the workpieces are removed from the workpiece table after processing. This can lead to long downtimes for the machine tool.

There are also other known machine tools, in which a so-called pivot carrier is swivel mounted on the machine frame, on which two rotatable workpiece tables are arranged that are positioned on opposite sides of the pivot carrier with regard to the axis of rotation of the pivot carrier. By rotating the pivot carrier around the axis of rotation, one workpiece table is moved from a work area to a loading area and at the same time the workplace table in the loading area is moved to the work area. This can reduce downtimes.

The use of a pivot carrier does allow loading and unloading of the workpiece tables during production time but it requires increased distance of the work spindle to the axis of rotation of the pivot carriers in order to allow collision-free pivoting of the pivot carrier because of the pivoting circle of the pivot carrier.

### SUMMARY

One task of an embodiment of the invention is to propose a machine tool that can be loaded and unloaded during production time and in which the distance between the axis of rotation and the work spindle can be reduced.

This task is solved by a machine tool with a machine frame, with at least one work spindle which is mounted rotatably about a spindle axis, with at least one workpiece table which is associated with the at least one work spindle and which is mounted in the machine frame rotatably or pivotably about an axis of rotation, which comprises a closed, planar partition wall which extends over the entire width of the workpiece table transversely to the axis of rotation and over the entire length of the workpiece table parallel to the axis of rotation and through which the axis of rotation extends, and which comprises at least one first workpiece holder and at least one second workpiece holder, which are arranged on the workpiece table in a rotationally fixed manner on opposite sides of the partition wall with respect to the partition wall, wherein the workpiece table can be transferred at least in a loading and unloading mode of the machine tool during the production time into a separating position, in which the partition wall is arranged extending transversely to the associated spindle axis and a working area, in which the first or the second workpiece holder is arranged in the separating position and is accessible to the associated work spindle, spatially separated from a loading area in which the second or first workpiece holder is arranged in the separation position.

As the workpiece table comprises a planar partition wall that extends across the entire width of the workpiece table transverse to the axis of rotation and along the entire length of the workpiece table parallel to the axis of rotation, a spatial separation of the work area and the loading area can be achieved in the separation position. The enables the loading and unloading of the workpiece holder arranged in the loading area during production time. Loading and unloading during production time means that the workpiece holder can be loaded and unloaded while the workpiece holder that is arranged in the work area is processed by the work spindle at the same time. This can reduce machine downtimes and improve processing times.

The workpiece table can be positioned at a desired angle to the axis of rotation. This means that the axis of rotation represents a full axis.

In principle it is conceivable that only a single first workpiece holder and only a single second workpiece holder is provided on the workpiece table. In addition, embodiments are conceivable in which two first workpiece holders and two second workpiece holders or at least three first workpiece holders and at least three second workpiece holders are arranged on the workpiece table.

The partition wall can be designed as a clamping bridge. In this case, the partition wall is designed to absorb forces and loads.

The at least one first workpiece holder and the at least one second workpiece holder are each designed to hold and fix at least one workpiece.

In addition to operating the machine tool in a loading and unloading mode during production time, the machine tool can also be operated in other operating modes.

In a further development of the machine tool, it proves to be advantageous if the workpiece table can be positioned in a working mode from a first processing swivelling area, within which at least one of the at least one first workpiece holder in the working area can be positioned in at least one working position relative to the machine frame by swivelling or rotating the workpiece table about the axis of rotation and can be fixed in position by fixing the workpiece table in a rotationally fixed manner, and transferred into a second processing swivelling area, within which at least one of the at least one second workpiece holder in the working area can be positioned in at least one working position relative to the machine frame by swivelling or rotating the workpiece table about the axis of rotation and can be fixed in position by fixing the workpiece table in a rotationally fixed manner.

In that the workpiece table can be positioned in a working mode from a first machining swivelling area the first workpiece holder at the working area for swivelling or rotating the workpiece table about the axis of rotation at least one working position relative to the machine frame and can be fixed in position by fixing the workpiece table in a rotationally fixed manner, the first workpiece holder can be positioned differently relative to the work spindle, wherein a workpiece arranged on the first workpiece holder can be processed from different sides.

The same applies accordingly in the second processing swivelling area for the second workpiece holder.

In one embodiment of the machine tool, it is provided that the first workpiece holder and the second workpiece holder are arranged symmetrically, in particular point-symmetrically, in relation to each other with respect to the axis of rotation and are fixed to the workpiece table in a rotationally fixed and aligned manner.

As the first workpiece holder and the second workpiece holder are arranged symmetrically, in particular point-symmetrically to one another with respect to the axis of rotation and are fixed to the workpiece table in a rotationally fixed and aligned manner, at least one workpiece can be processed by the work spindle on the relevant workpiece holder when the workpiece table is rotated or swivelled about 180°, without the work spindle needing to be moved from its position over a long travel path. This allows the further optimisation of processing times.

In particular, if the first workpiece holder and the second workpiece holder are arranged point-symmetrically to one another with regard to the axis of rotation and are fixed to the workpiece table in a rotationally fixed and aligned manner, it proves to be advantageous if the first workpiece holder and the second workpiece holder are arranged, viewed in a plane parallel to the separating surface of the partition wall, offset from each other without overlapping in the direction transverse to the axis of rotation.

In this way an interlocked arrangement of the first workpiece holder and the second workpiece holder can be achieved during processing by the work spindle, thus enabling further reduction of the distance between the work spindle and the axis of rotation.

Embodiments of the machine tool are conceivable in which the axis of rotation of the workpiece table runs parallel to a horizontally extending X-axis or parallel to a vertically extending Y-axis and/or in which the spindle axis of the work spindle runs parallel to a horizontally extending Z-axis, which runs transverse to the vertically extending Y-axis and transverse to the horizontally extending X-axis.

If the axis of rotation of the workpiece table runs parallel to a horizontally extending X-axis, the first workpiece holder and the second workpiece holder can also include their longest extension, that is their longitudinal direction, parallel to the horizontally extending X-axis.

If the axis of rotation of the workpiece table runs parallel to a vertically extending Y-axis, the at least one first workpiece holder and the at least one second workpiece holder can also include their longest extension, that is their longitudinal direction, also parallel to the Y-axis.

In order to simplify the processing of workpieces arranged on a workpiece holder, it proves to be advantageous if the partition wall of the workpiece table comprises at least one continuous opening extending transversely to the axis of rotation, through which the partition wall can be crossed by the work spindle, and a workpiece holder arranged in the loading area is accessible to the engaging work spindle, and if the partition wall comprises at least one planar closure means arranged in or on the at least one opening and which can be transferred from a release position, in which the closure means releases the opening at least in the direction transverse to the axis of rotation in its entirety or in sections, to a closure position, in which the closure means closes the opening in its entirety at least in the direction transverse to the axis of rotation, wherein the closure element is allocated to the machine tool in the closed position in loading and unloading mode during production.

As the partition wall on the workpiece table comprises at least one continuous opening, the work spindle can engage through the opening from the work area and process a workpiece from one side that is arranged in the arrangement of the workpiece in the work area on the side facing away from the work spindle. This allows a workpiece that is arranged in a workpiece holder to be better processed from all sides.

This proves to be advantageous especially if the first workpiece holder and the second workpiece holder, viewed in a plane parallel to the separating surface of the partition wall, are offset from each other in a direction transverse to the axis of rotation without overlapping. This ensures that the workpiece holders located in the work area are arranged collision-free with regard to the work spindle if this grips through the opening in the partition wall towards the workpiece holders in the loading area.

As the partition wall simultaneously comprises a flat closure means which is arranged in or on the at least one opening and which, in the closed position, completely closes the opening at least in the direction transverse to the axis of rotation, it is ensured that the loading area is completely shielded from the work spindle by the partition wall in the loading and unloading mode of the machine tool. In a further development of the latter embodiment, it proves to be advantageous if the at least one opening comprises at least one guide, such as a groove or projection, through which the transfer of the closure means from the release position to the closed position and back can be guided and is secured against movement transverse to the transfer direction and/or if the closure means is designed like a sliding door and comprises at least one planar, in particular plate-like, door element or if the closure means is designed like a roller shutter and comprises a plurality of lamellar closure elements.

Through the provision of a guide, such as a groove or projection, the closure means can be moved, guided during transfer from the release position to the closure position and back. In addition, the closure means is held by the guide in a direction transverse to the transfer direction.

If the closure means comprises at least one planar, in particular plate-like, door element, the closure means can be constructed simply.

If the closure means is designed like a roller shutter and comprises a plurality of lamellar closure elements, the closure means can be kept compact in the release position.

In such cases, the closure means can be wound, in particular rolled up, on a drum element arranged inside the partition wall. It is conceivable here that the drum element comprises a drive with which the drum element can be rotated about an axis of rotation, thereby rolling up or winding up the closure means. The closure means can be pre-tensioned in the closure position. If this is the case, the closure means must be actively moved into the release position against the pre-tension by the drum element. This embodiment has the advantage that in the event of a malfunction of the drum element or the drive for the drum element, the closure means is automatically transferred to the locked position, which ensures a high level of work safety for machine tool operators at all times.

In principle it is conceivable that a single opening is provided on the partition wall. In addition, it proves to be advantageous if the partition wall comprises a plurality of continuous openings extending transversely to the axis of rotation, which are each spaced apart from one another by bar sections of the partition wall, wherein each opening is assigned its own closure means or wherein at least two openings, in particular all openings of the partition wall, are assigned a common closure means.

The provision of a number of openings ensures that the partition wall can act as a clamping bridge, allowing loads and forces to be absorbed by the partition wall.

If the plurality of openings is allocated a common closure means, then the machine tool can be designed with a reduced number of components. If each opening is allocated its own closure means, then the openings can be released as necessary for the work spindle to engage through them.

In order to ensure that the partition wall can serve as a clamping bridge, it proves to be advantageous if the partition wall of the workpiece table comprises at least one load-bearing, supporting central bar section which extends parallel to the axis of rotation and through which the axis of rotation runs, and/or at least two load-bearing, supporting edge bar sections which extend parallel to the axis of rotation and form an outer edge of the partition wall, in particular wherein at least two openings, in particular at least four openings, are arranged between the central bar section and the edge bar section, each allocated their own or a common closure means.

By providing the central bar section and/or at least two edge bar sections extending parallel to the axis of rotation, it can be ensured that loads can be picked up and transported on in a direction parallel to the axis of rotation.

In order to accelerate the processing of workpieces arranged on the workpiece table, one embodiment of the machine tool comprises at least two work spindles which are assigned to the same workpiece table, wherein the spindle axes of the at least two work spindles assigned to the same workpiece table run parallel to one another and are arranged horizontally next to one another when the axis of rotation of the workpiece table runs parallel to a horizontally running X-axis, or are arranged vertically one above the other when the axis of rotation of the workpiece table runs parallel to a vertically running Y-axis.

By providing at least two work spindles that are assigned to the same workpiece table, it can be ensured that a workpiece holder arranged in the working area is processed by at least two work spindles. This can reduce processing times.

In order to increase further the number of the workpieces to be processed simultaneously by the machine tool, a further embodiment of the machine tool comprises at least two work spindles and at least two workpiece tables, wherein at least one first work spindle is allocated to a first workpiece table and is mounted to rotate or pivot about a first axis of rotation, and wherein at least one second work spindle is allocated to a second workpiece table that is mounted to rotate or pivot about a second axis of rotation, running parallel to the first axis of rotation and distanced from the first axis of rotation.

In this way, the machine tool comprises at least two workpiece tables that run parallel to one another.

The workpiece tables can be designed in such a way that they are directly adjacent to each other and are aligned with each other when the axis of rotation is horizontal and are arranged next to each other when the axis of rotation is vertical.

In addition, it proves to be advantageous if all workpiece tables are transferred to the separation position in the loading and unloading mode of the machine tool.

In addition, in a further embodiment of the machine tool, at least one further work spindle and at least one further workpiece table can be provided in a further embodiment of the machine tool, wherein the at least one further work spindle is allocated to the at least one further workpiece table, which is mounted in the machine frame so as to be rotatable or pivotable about a further axis of rotation, which runs parallel to the first axis of rotation and which is spaced apart from the first and second axes of rotation.

In this way, the machine tool can comprise at least three workpiece tables, which are arranged one above the other and aligned with each other when the axes of rotation run horizontally and are arranged in a row next to each other when the axes of rotation run vertically.

In the above-mentioned embodiments only a first work spindle, a second work spindle and a further work spindle can be provided in each case. In addition, embodiments are conceivable in which several, in particular two, three or four first work spindles, second work spindles and further work spindles are provided, which are each allocated to the first workpiece table, second workpiece tables and/or the further workpiece table.

The term “and/or” is used in the classic sense to mean “and in the other case”.

If several workpiece tables are provided, it is advantageous if the first workpiece table and the second workpiece table or the first workpiece table, the second workpiece table and the at least one further workpiece table can be moved separately and independently of one another into the separating position in an independent operating mode, in particular decoupled with respect to their kinematics, into the first processing swivelling area and into the second processing swivelling area and/or in a dependent operating mode, in particular coupled with respect to their kinematics, can be moved jointly and simultaneously into the separating position, into the first processing swivelling area and into the second processing swivelling area.

If the individual workpiece tables can be moved, decoupled from one another, separately and independently, in independent operating mode, into the first processing swivelling area and into the second processing swivelling area, then the machine tool can be used more flexibly. If all workpiece tables can be moved together and at the same time into the separation position, into the first processing swivelling area and into the second processing swivelling area, then it is easier to process identical workpieces.

Furthermore, it proves to be advantageous if the at least one first working spindle and the at least one second working spindle or that the at least one first working spindle, the at least one second working spindle and the at least one further working spindle are decoupled with respect to their kinematics, can be operated and/or moved separately and independently of one another and/or are coupled with respect to their kinematics, can be operated and/or moved together and simultaneously.

In this way, the independent operating mode and the dependent operating mode can be realised more easily with work spindles that are decoupled from one another or coupled with one another.

In order to ensure collision-free processing, in one embodiment of the machine tool it is provided that the at least one first work spindle and the at least one second work spindle or that the at least one first work spindle, the at least one second work spindle and the at least one further work spindle are arranged vertically over one another if the axes of rotation of the workpiece tables run parallel to a horizontally extending X-axis, or are arranged horizontally next to one another if the axes of rotation of the workpiece tables run parallel to a vertically extending Y-axis.

Further features, details and advantages of the invention are apparent from the appended patent claims, from the drawing and from the following description of a preferred embodiment of the machine tool.

### BRIEF DESCRIPTION OF THE DRAWINGS

The drawing shows:

FIG. 1A schematic side view of a machine tool according to the invention with two workpiece tables;

FIG. 2A perspective side view of the machine tool as shown in FIG. 1, in which the workpiece holders of the second workpiece table are hidden;

FIG. 3A perspective side view of the illustration according to FIG. 2 with a first workpiece table in a rotated arrangement with respect to the separating position.

### DETAILED DESCRIPTION

The figures show a machine tool labelled as a whole with the reference number 2. This comprises a machine frame (not shown in the figures).

In the embodiment shown in the figures, the machine tool 2 comprises several work spindles 4, each mounted to rotate around a spindle axis 6. In the embodiment shown in the figures, the work spindles 4 are mounted to rotate around a spindle axis 6, which run parallel to a horizontally extending Z-axis. Both work spindles 4 are arranged above one another and aligned with one another with regard to a vertically extending Y-axis.

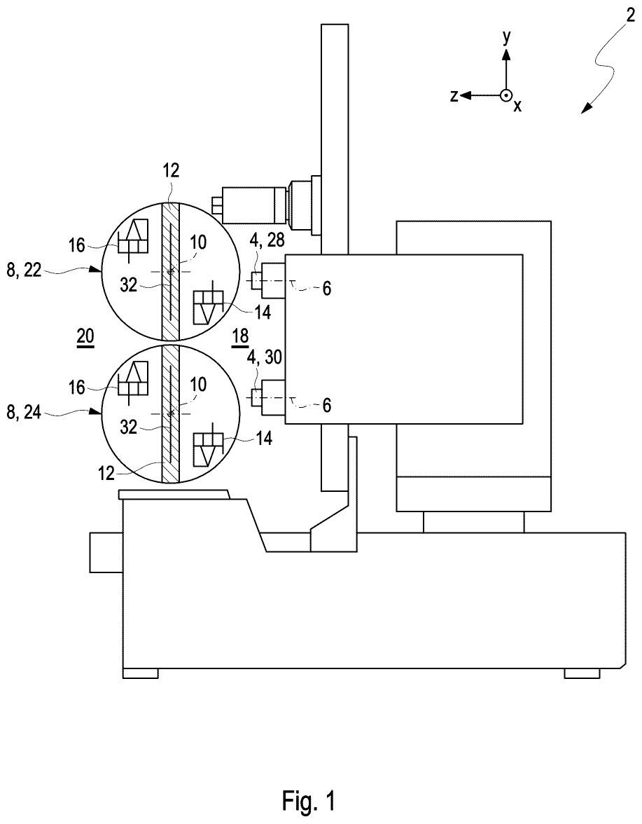

In addition, the embodiment of the machine tool 2 shown in FIGS. 1 to 3 comprises two workpiece tables 8 that are each mounted in the machine frame to rotate and/or pivot about an axis of rotation 10. The axis of rotation 10 runs parallel to a horizontally extending X-axis.

Each workpiece table 8 comprises a closed, planar partition wall 12 that extends over the entire width of the workpiece table 8, transverse to the axis of rotation 10, and over the entire length of the workpiece table 8, parallel to the axis of rotation 10. The axis of rotation 10 runs within the partition wall 12.

In addition, each workpiece table 8 comprises a first workpiece holder 14 and a second workpiece holder 16. The first workpiece holder 14 and the second workpiece holder 16 are arranged non-rotatably on the workpiece table 8 on opposite sides of the partition wall 12 with respect to the partition wall 12.

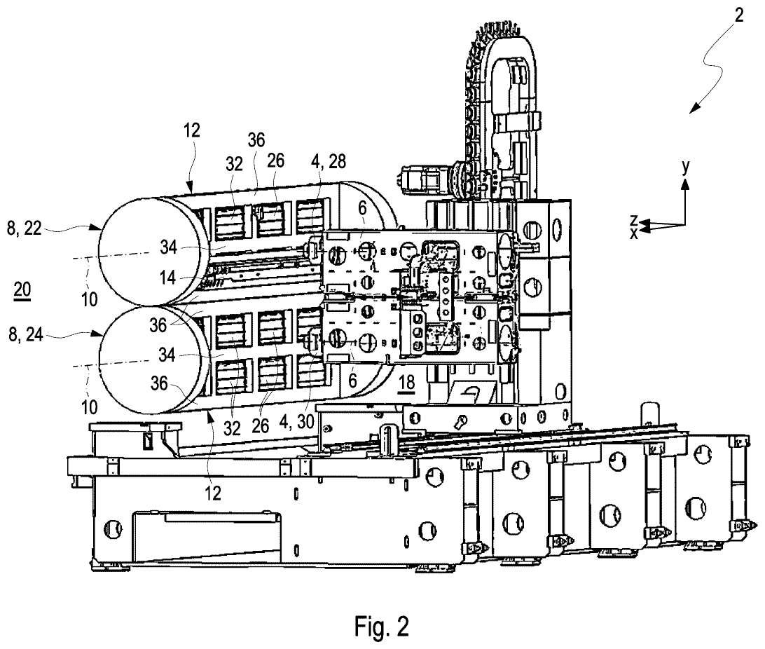

FIGS. 1 and 2 show the machine tool 2 in a loading and unloading mode parallel to production. In this mode the workpiece tables 8 are transferred to a separation position, in which die relevant partition walls 12 are arranged running transverse to the allocated spindle axis 6 and a work area 18, in which the first workpiece holder 14 is arranged in the separating position in the embodiment example shown in the figures. Here, the second workpiece holder 16 is arranged in a loading area 20. Here, the partition wall 12 separates the work area 18 spatially from the loading area 20 in the separating position.

In the embodiment shown in the figures, a first workpiece table 22 is arranged above a second workpiece table 24. The work areas 18 of the two workpiece tables 22, 24 are not separated from one another here and form a common work area 18. The same is valid for the loading area 20.

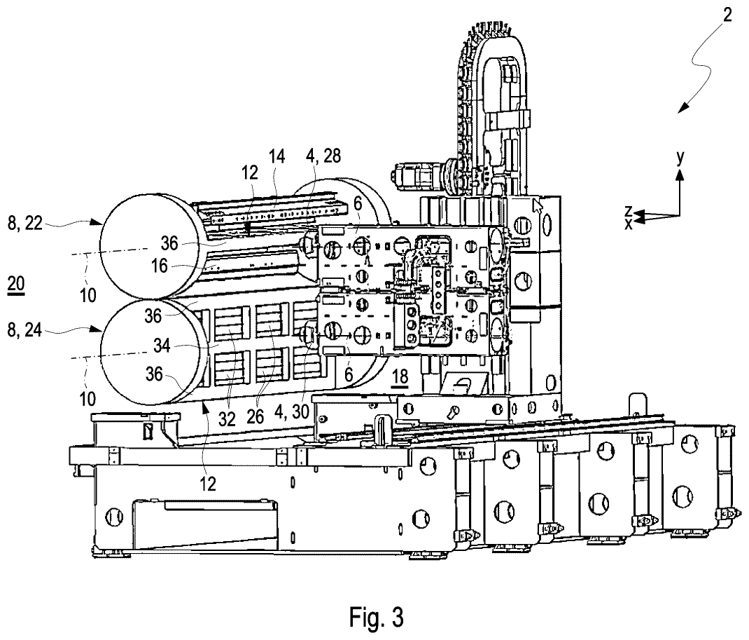

As can be seen in FIG. 3, in a working mode, the individual workpiece tables 8 can be positioned from a first processing swivelling area, within which at least one of the at least one workpiece holders 14, 16 in the working area 18 in at least one working position relative to the machine frame by swivelling or rotating the workpiece table 8 about the axis of rotation 10 and can be fixed in position by fixing the workpiece table 8 in a rotationally fixed manner.

In a second processing swivelling area, within which at least one of the at least one second workpiece holders 16 in the working area 18 can be positioned in at least one working position relative to the machine frame by swivelling or rotating the workpiece table 8 about the axis of rotation 10 and can be fixed in position by fixing the workpiece table 8 in a rotationally fixed manner.

The first workpiece holder 14 and the second workpiece holder 16 are fixed to the workpiece table 8 in a rotationally fixed manner, arranged point-symmetrically with respect to the axis of rotation 10. Here, the first workpiece holder 14 and the second workpiece holder 16 are arranged in a plane parallel to the separating surface of the partition wall 12, viewed in a direction transverse to the axis of rotation 10, offset from one another without overlapping.

This allows the relevant work spindle 4 to engage without collision through a continuous opening 26 arranged in the partition wall 12 extending transverse to the axis of rotation 10. Here, the first work spindle 28 can engage through the openings 26 in the first workpiece table 22 and a second work spindle 30 can engage through the openings 26 in the second workpiece table 24. In the embodiment shown in the figures closure means 32 are arranged in the opening 26 that are arranged in a closure position in the embodiment shown in the figures. In a closure position, the openings 26 are closed entirely by the closure means 32 in a direction transverse to the axis of rotation 10. The closure means 32 can also be transferred to a release position in which the opening 26 is released entirely or at least in sections (not shown in the figures).

In the embodiments shown in the figures eight openings 26 are arranged in each workpiece table 8. Here, four of the eight openings 26 are each arranged between a central bar section 34 and an edge bar section 36.

FIG. 1 shows a schematic side view of the machine tool 2. In FIG. 1 we can see that the first workpiece table 22 and the second workpiece table 24 are arranged above and aligned to one another with regard to a vertically extending Y-axis. Furthermore, the first workpiece table 22 and the second workpiece table 24 are at least almost adjacent to one another.

FIG. 2 shows the machine tool 2 according to FIG. 1 in an isometric side view. Here, the first workpiece holder 14 of the second workpiece table 24 was hidden in order to allow an unhindered view of the eight openings 26 and the closure means 32 arranged in them. In the illustration according to FIGS. 1 and 2 both workpiece tables 8 are in the separating position, in which the partition wall 12 separates the work area 18 from the loading area 20.

FIG. 3 shows the machine tool 2 in the FIGS. 1 and 2, in which the first workpiece table 22 is rotated in relation to the separation position.

The features of the invention disclosed in the above description, in the claims as well as in the drawing, both individually and in any combination, may be essential in the realisation of the invention in its various embodiments within the scope of protection of the following claims.

### REFERENCE SYMBOL LIST

2 Machine tool
4 Work spindle
6 Spindle axis
8 Workpiece table
10 Axis of rotation
12 Partition wall
14 First workpiece holder
16 Second workpiece holder
18 Working area
20 Loading area
22 First workpiece table
24 Second workpiece table
26 Opening
28 First work spindle
30 Second work spindle
32 Closure means
34 Central bar section
36 Edge bar section

1. A machine tool comprising:
a machine frame,
at least one work spindle which is mounted to rotate about a spindle axis,
at least one workpiece table which is allocated to the at least one work spindle and which is mounted in the machine frame to rotate or swivel about an axis of rotation and which comprises a closed, planar partition wall, which extends over an entire width of the workpiece table transversely to the axis of rotation and over an entire length of the workpiece table parallel to the axis of rotation and through which the axis of rotation extends, and which comprises at least one first workpiece holder and at least one second workpiece holder, which are arranged on the workpiece table in a rotationally fixed manner with respect to the partition wall on opposite sides of the partition wall,
wherein the workpiece table, at least in a loading and unloading mode of the machine tool during production, can be transferred into a separating position in which the separating wall is arranged to extend transversely to the allocated spindle axis and spatially separates a working area, in which the first or the second workpiece holder is arranged in the separating position and is accessible to the assigned work spindle, from a loading area, in which the second or the first workpiece holder is arranged in the separating position and/or the first workpiece holder is arranged in the separating position.

2. The machine tool according to claim 1, wherein the workpiece table can be moved in a working mode from a first processing swivelling area, within which at least one of the at least one first workpiece holder in the working area can be positioned in at least one working position relative to the machine frame by swivelling or rotating the workpiece table about the axis of rotation and can be fixed in position by fixing the workpiece table in a rotationally fixed manner, can be transferred into a second processing swivelling area, within which at least one of the at least one second workpiece holder in the working area can be positioned in at least one working position relative to the machine frame by swivelling or rotating the workpiece table about the axis of rotation and can be fixed in place by fixing the workpiece table in a rotationally fixed manner.

3. The machine tool according to claim 1, wherein the first workpiece holder and the second workpiece holder are arranged and aligned symmetrically, in particular point symmetrically to one another with regard to the axis of rotation and are attached in a non rotatable manner on the workpiece table.

4. The machine tool according to claim 1, wherein the first workpiece holder and the second workpiece holder are arranged in a plane parallel to the separating surface of the partition wall, viewed in a direction transverse to the axis of rotation, offset from one another without overlapping.

5. The machine tool according to claim 1, wherein the axis of rotation of the workpiece table runs parallel to a horizontally extending X-axis or parallel to a vertically extending Y-axis and/or that the spindle axis of the work spindle runs parallel to a horizontally extending Z-axis, which runs transverse to the vertically extending Y-axis and transverse to the horizontally extending X-axis.

6. The machine tool according to claim 1, wherein the partition wall of the workpiece table comprises at least one continuous opening which extends transversely to the axis of rotation and through which the partition wall can be engaged by the work spindle, and a workpiece holder of the work spindle arranged in the loading area is accessible, and in that the partition wall comprises at least one planar closure means, which is arranged in or on the at least one opening and which can be transferred from a release position, in which the closure means releases the opening at least in the direction transverse to the axis of rotation in its entirety or in sections, into a closure position, in which the closing means closes the opening completely at least in the direction transverse to the axis of rotation, wherein the closing element is arranged in the closing position in the loading and unloading mode of the machine tool during production.

7. The machine tool according to claim 6, wherein the at least one opening comprises at least one guide, such as a groove or projection, through which the transfer of the locking means from the release position into the locking position and back can be guided and is secured against movement transversely to the transfer direction and/or in that the locking means is of sliding door design and comprises at least one planar, in particular plate-like, door element or in that the locking means is of roller shutter design and comprises a plurality of lamellar locking elements.

8. The machine tool according to claim 6, wherein the partition wall comprises a plurality of continuous openings extending transversely to the axis of rotation, which are each spaced apart from one another by bar sections of the partition wall, wherein each opening is assigned its own closure means or wherein at least two openings, in particular all openings of the partition wall, are assigned a common closure means.

9. The machine tool according to claim 8, wherein the partition wall of the workpiece table comprises at least one central bar section extending parallel to the axis of rotation, through which the axis of rotation runs, and/or at least two load-bearing, supporting edge bar sections extending parallel to the axis of rotation, which form an outer edge of the partition wall, in particular wherein in each case at least two, in particular at least four, openings are arranged between the central bar section and the edge bar section, to each of which a separate or a common closure means is assigned.

10. The machine tool according to claim 1, wherein at least two work spindles, which are assigned to the same workpiece table, wherein the spindle axes of the at least two work spindles assigned to the same workpiece table run parallel to one another and are arranged horizontally next to one another where the axis of rotation of the workpiece table runs parallel to a horizontally extending X-axis, or are arranged vertically one above the other where the axis of rotation of the workpiece table runs parallel to a vertically running Y-axis.

11. The machine tool according to claim 1, wherein it has at least two work spindles and at least two workpiece tables, at least one first work spindle being assigned to a first workpiece table which is mounted in the machine frame so as to be rotatable or pivotable about a first axis of rotation, and wherein at least one second work spindle is assigned to a second workpiece table, which is mounted in the machine frame or in the pivot carrier so as to be rotatable or pivotable about a second axis of rotation, which runs parallel to the first axis of rotation and is spaced apart from the first axis of rotation.

12. The machine tool according to claim 11, wherein it has at least one further work spindle and at least one further workpiece table, wherein the at least one further work spindle is associated with the at least one further workpiece table, which is mounted in the machine frame so as to be rotatable or pivotable about a further axis of rotation, which runs parallel to the first axis of rotation and is spaced apart from the first and second axes of rotation.

13. The machine tool according to claim 11, wherein the first workpiece table and the second workpiece table or that the first workpiece table, the second workpiece table and the at least one further workpiece table are decoupled in an independent operating mode, in particular with respect to their kinematics, can be moved separately and independently of one another into the separating position, into the first processing swivelling area and into the second processing swivelling area and/or in a dependent operating mode, in particular coupled with respect to their kinematics, can be moved jointly and simultaneously into the separating position, into the first processing swivelling area and into the second processing swivelling area.

14. The machine tool according to claim 11, wherein the at least one first work spindle and the at least one second work spindle or that the at least one first work spindle, the at least one second work spindle and the at least one further work spindle are decoupled with respect to their kinematics, can be operated and/or moved separately and independently of one another and/or are coupled with respect to their kinematics, can be operated and/or moved together and simultaneously.

15. The machine tool according to claim 11, wherein the at least one first work spindle and the at least one second work spindle or that the at least one first work spindle, the at least one second work spindle and the at least one further work spindle are arranged vertically one above the other, if the axes of rotation of the workpiece tables run parallel to a horizontally extending X-axis, or are arranged horizontally next to one another if the axes of rotation of the workpiece tables run parallel to a vertically extending Y-axis.
